(19) United States
(12) Patent Application Publication
(10) Pub. No.: US 2022/0234223 A1
(43) Pub. Date: Jul. 28, 2022

(54) Smoothing Apparatus for Utility Knife

(71) Applicant: Macario A. Sanchez, Rochester, MN (US)

(72) Inventor: Macario A. Sanchez, Rochester, MN (US)

(21) Appl. No.: 17/155,973

(22) Filed: Jan. 22, 2021

(51) Int. Cl. B26B 11/00; B26B 5/00

(52) U.S. Cl. CPC B26B 11/00; B24D 15/02; B26B 5/00

(57) ABSTRACT

The present invention provides a utility knife having built in smoothing capabilities, either in the form of a utility knife with a grooved cavity for inserting a removable smoothing element with an abrasive surface, or in the form of a utility knife that has an abrasive surface etched into a portion of the utility knife handle. The invention further provides a smoothing element attachment for retrofitting suitable utility knives.

### FIELD OF INVENTION

The present invention relates generally to the field of construction tools. More specifically the present invention relates to a smoothing apparatus for increased convenience of utility knives when working with drywall.

### BACKGROUND

Drywall (also known as plasterboard) is a panel made of calcium sulfate dihydrate (gypsum), with or without additives. It is typically extruded between thick sheets of facer and backer paper. It is very important in the construction industry and is often used in the construction of interior walls and ceilings.

To install drywall sheets, a worker must make different cuts of the drywall according to the measurements or dimensions of the area in which the sheets are to be installed. When a cut is made in a drywall sheet using a cutting tool such as a utility knife, two separate pieces remain each having a rough edge where the cut was made. These edges must be smoothed on site by passing a separate tool such as a scraper across them to give a better finish and therefore fit to the drywall pieces.

It is within this context that the present invention is provided.

### SUMMARY

The present invention provides a utility knife having built in smoothing capabilities, either in the form of a utility knife with a grooved cavity for inserting a removable smoothing element with an abrasive surface, or in the form of a utility knife that has an abrasive surface etched into a portion of the utility knife handle. The invention further provides a smoothing element attachment for retrofitting suitable utility knives.

The distinguishing features of the present invention have the benefit that a worker can have two tools in one, always at hand. This also lowers costs, since the tool has programmed obsolescence in terms of manufacturing as opposed to companies offer the public somewhat more expensive the replacement blade than the tool.

Furthermore, the present invention provides increased practicality for users who are tired of carrying all kinds of tools in their tool bags.

Thus, according to a first aspect of the present invention, there is provided a utility knife, the utility knife comprising: a first end housing a blade; a middle grip section; a second opposing end having a grooved cavity structured to receive and hold a smoothing element; and a removable smoothing element having a flat surface with an abrasive area.

The abrasive area of the smoothing element may comprise one or more spikes in an array.

In some embodiments, the smoothing element is a flat piece of rigid material.

The grooved cavity may comprise a slot having dimensions matching the smoothing element and further comprises two ridges which overhang opposing sides of the smoothing element when in place in the utility knife. The grooved cavity may also or alternatively comprise a backstop at a distance equal to the length of the smoothing element form the front of the cavity.

In some embodiments, the smoothing element further comprises an attachment element along a first edge of the flat piece. The attachment element may be in the form of an extended portion having a first opening for a screw, with the grooved cavity further comprising a second opening having matching dimensions to the first opening such that a screw may be inserted through both openings to bind the smoothing element in place in the grooved cavity.

The rigid material of the smoothing element is aluminium, however other materials or composites of materials could also be used.

In other embodiments, the smoothing element comprises a flat piece of rigid material set into a frame, the frame being shaped to slot into the grooved cavity.

According to a second aspect of the present invention, there is provided an attachment for a utility knife, the attachment comprising a smoothing element in the form of a flat piece of rigid material set into a frame, the flat piece of rigid material having a flat surface with an abrasive area comprising a plurality of spikes extending from the surface.

According to a third aspect of the present invention, there is provided a utility knife, the utility knife comprising: a first end housing a blade; a middle grip section; and a second opposing end having inset therein a flat surface with an abrasive area comprising a plurality of spikes extending from the surface.

### BRIEF DESCRIPTION OF THE DRAWINGS

Various embodiments of the invention are disclosed in the following detailed description and accompanying drawings.

FIG. 1 illustrates a perspective view of an example configuration of a first embodiment of the present invention.

FIG. 2 illustrates a close up view of an example configuration of a first embodiment of the present invention.

FIG. 3 illustrates a side view of an example configuration of a first embodiment of the present invention.

FIG. 4 illustrates a second perspective view of an example configuration of a first embodiment of the present invention.

FIG. 5 illustrates a realistic view of an example configuration of a first embodiment of the present invention.

FIG. 6 illustrates a plurality of views of a component of the first embodiment of the present invention.

FIG. 7 illustrates two views of an example configuration of a first embodiment of the present invention having example dimensions.

FIG. 8 illustrates a perspective view of an example configuration of a second embodiment of the present invention.

FIG. 9 illustrates a side view of an example configuration of a second embodiment of the present invention.

FIG. 10 illustrates a perspective view of an example configuration of a third embodiment of the present invention.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

For context, it should be noted that drywall is a resistant material, but is nonetheless composed of powders that have been compacted. Furthermore, although the present invention has been explained with reference to a thick, fixed blade utility knife, it should be noted that utility knives come in various classes, all of which would be suitable for use with the present invention.

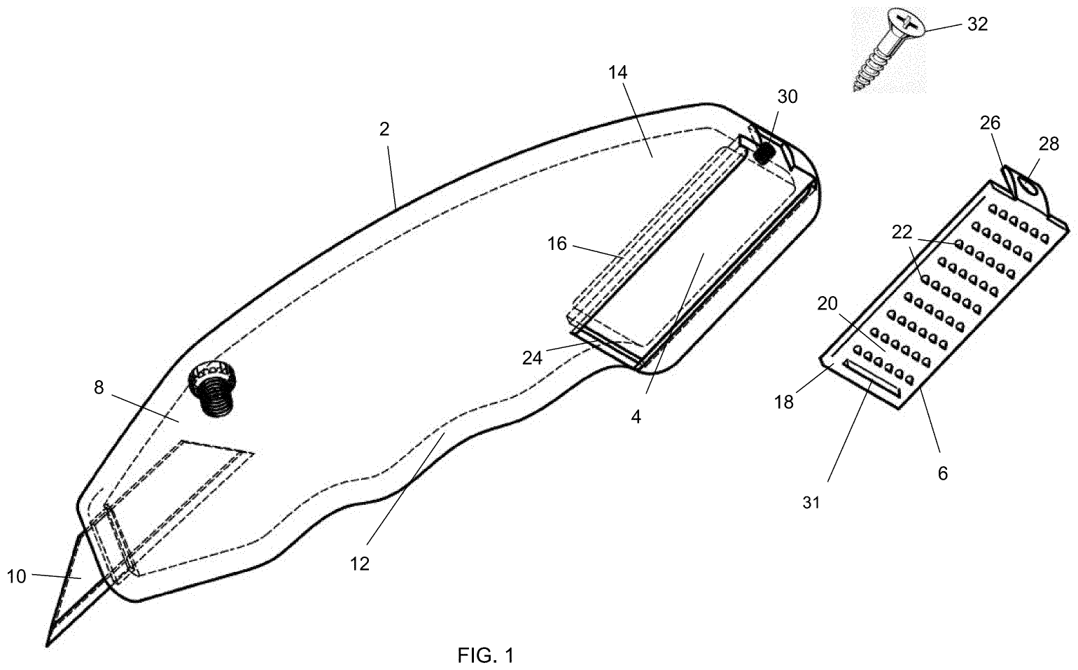

Referring to FIG. 1, a perspective view of an example configuration of a first embodiment of the present invention is shown where the utility knife 2 comprises a grooved cavity 4 and a removable smoothing element 6.

Specifically, the utility knife 2 comprises a first end 8 housing a blade 10. In the present example a fixed blade utility knife is illustrated, however retractable embodiments are also possible. The knife further comprises a middle grip section 12 and a second opposing end 14 where the novel features of the invention are installed.

The novel features of the present embodiment are in the form of the grooved cavity 4 set into the back of the utility knife 2. The grooved cavity 4 is shaped to receive and hold the smoothing element 6, the groove structures 16 of the cavity are represented by the dashed lines.

The smoothing element 6 itself in the present example is in the form of a flat piece of rigid material having a surface 18 with an abrasive area 20. The abrasive area in the present example being formed by a plurality of spikes 22 formatted in a grid—however it will be recognised by the skilled person that many different shapes not illustrated herein could also form suitable abrasive regions.

The groove structures 16 are such that the smoothing element may be slotted into the cavity and thereby be enclosed along its entire length by overhanging portions that prevent it from falling out. The overhanging portions also act as a guide from running the smoothing element along a piece of drywall since they extend above the abrasive surface of the smoothing element, this also increases safety. In order to achieve this, and to have a snug fit between the smoothing element 6 and the grooved cavity 4, the grooved structures 16 have a length equal to the length of the smoothing element and are separated by a width approximately equal to the width of the smoothing element. As illustrated, the grooved cavity may comprise a backstop 24 at a distance equal to the length of the smoothing element from the front of the cavity, to prevent the smoothing element 6 sliding out of the back of the cavity 4.

Advantageously, when slid into place in the grooved cavity at the back of the knife, the smoothing element provides a quick and convenient tool for a worker who has made a cut in a piece of drywall to scrape the rough edges produced by the cut, without any additional tools needed and with the simple motion of turning the utility knife around.

Optionally, and as illustrated in the present example, the utility knife 2 and smoothing element 6 may come with further attachment means for preventing the smoothing element 6 from sliding out of the grooved structures 16. In the present example, the attachment means are in the form of an extended portion 26 having a first opening 28 for a screw, with the grooved cavity further comprising a second opening 30 having matching dimensions to the first opening such that a screw may be inserted through both openings to bind the smoothing element in place in the grooved cavity.

Attachment means are not always necessary, as long as the grooved cavity 4 comprises a backstop to prevent the smoothing element 6 from sliding out the back when pressure is applied the device can function well.

Another optional feature illustrated in FIG. 1 is a raised ridge 31 on the surface of the smoothing element 6, located adjacent to the grid of spikes 22. Advantageously, any detritus that is caused by the smoothing element 6 smoothing rough edges is swept away from the edges by the raised ridge 31.

The smoothing element must be made from rigid material such as for example, but not limited to, aluminium. Composites of different materials could also be used. Other suitable materials for constructing the utility knife may include but are not limited to ABS plastic and carbon fiber.

The smoothing element may be made of the same or different material to the knife itself. Preferably, the material is a different material such as high carbon content hardened steel. The smoothing element can be used to smooth rough surfaces of materials such as drywall or even wood, soft metals, acrylic, glass, PVC material.

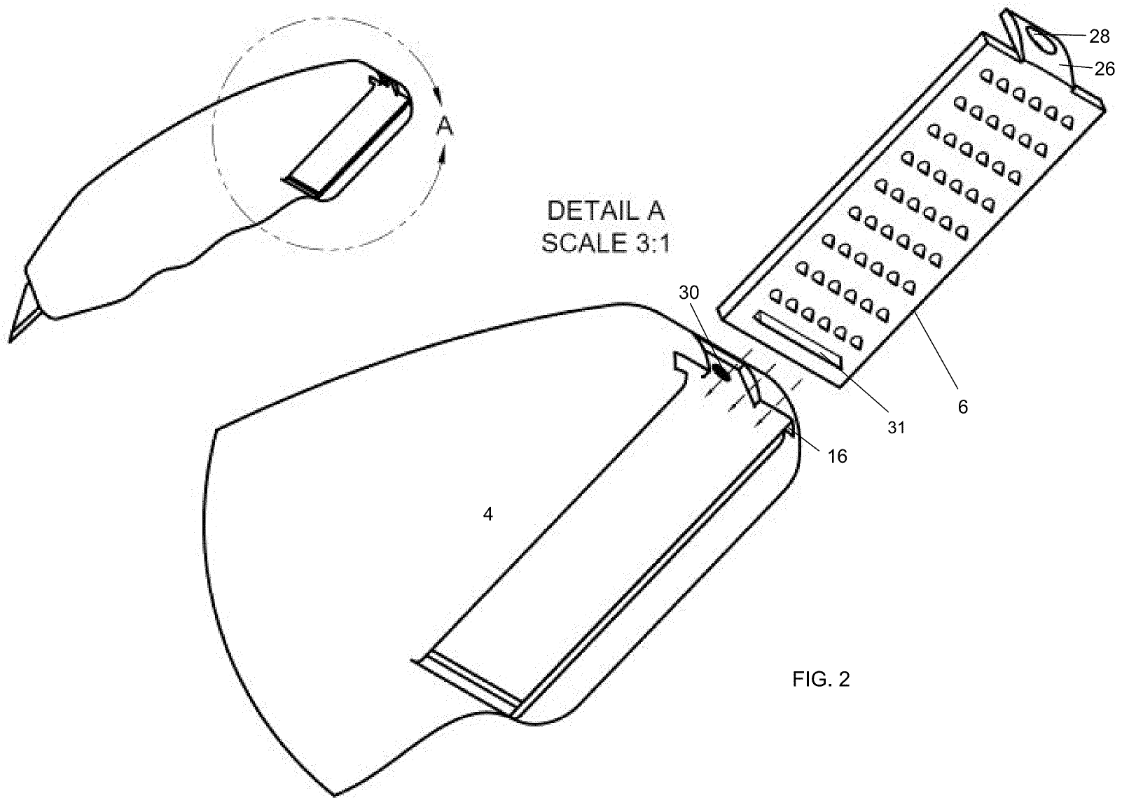

Referring to FIG. 2, a close-up view of the same configuration is shown, with motion lines indicating the insertion of the smoothing element 6 into the slot formed by the grooved structures 16 of the grooved cavity 4.

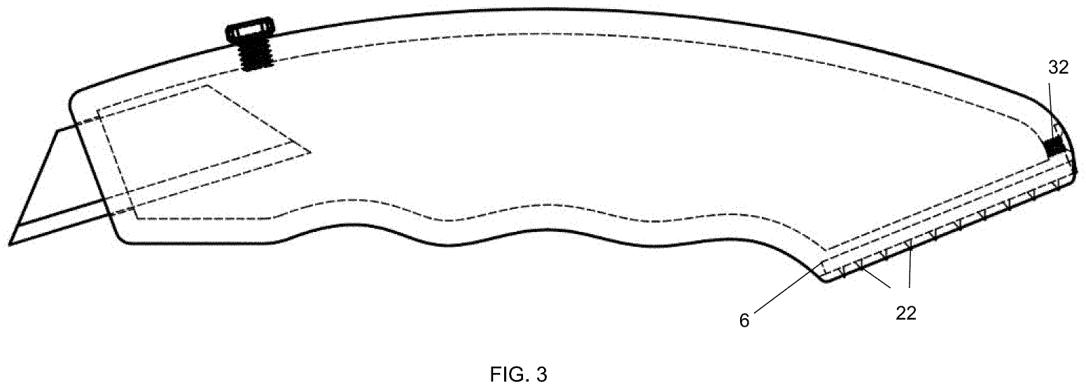

Referring to FIG. 3, a side view of the same configuration is shown, with the smoothing element 6 having been inserted into the grooved cavity 4, and having been fastened in place via the example attachment means. Specifically, a screw 32 has been inserted through openings 28 and 30. Spikes 22 of the smoothing element 6 are shown as pointing outwards, in position ready to smooth a piece of drywall.

A person skilled in the art will recognise that various other suitable attachment means could be used other than that illustrated herein.

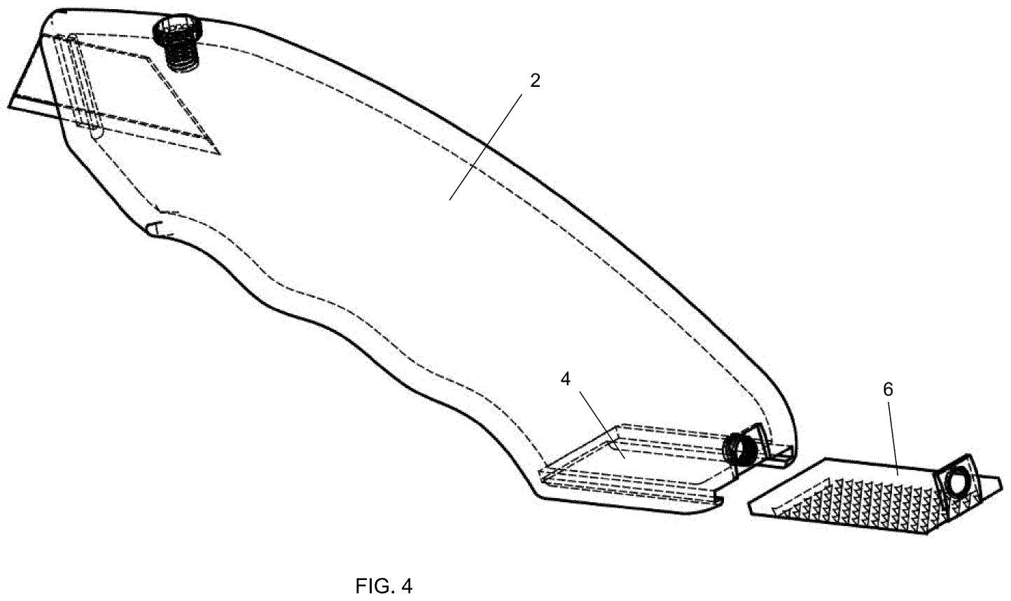

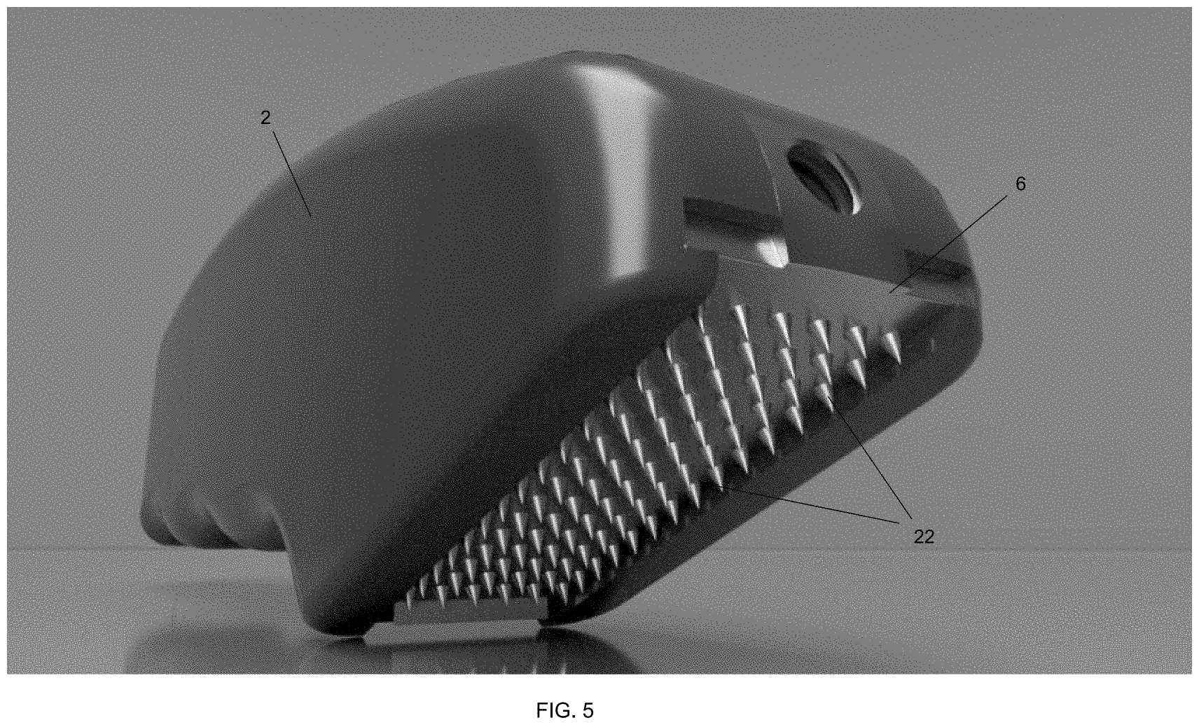

FIGS. 4 and 5 illustrate further perspective views of the apparatus, FIG. 5 showing a CAD version of the assembled utility knife 2 with the smoothing element 6 slotted in place but not screwed in place.

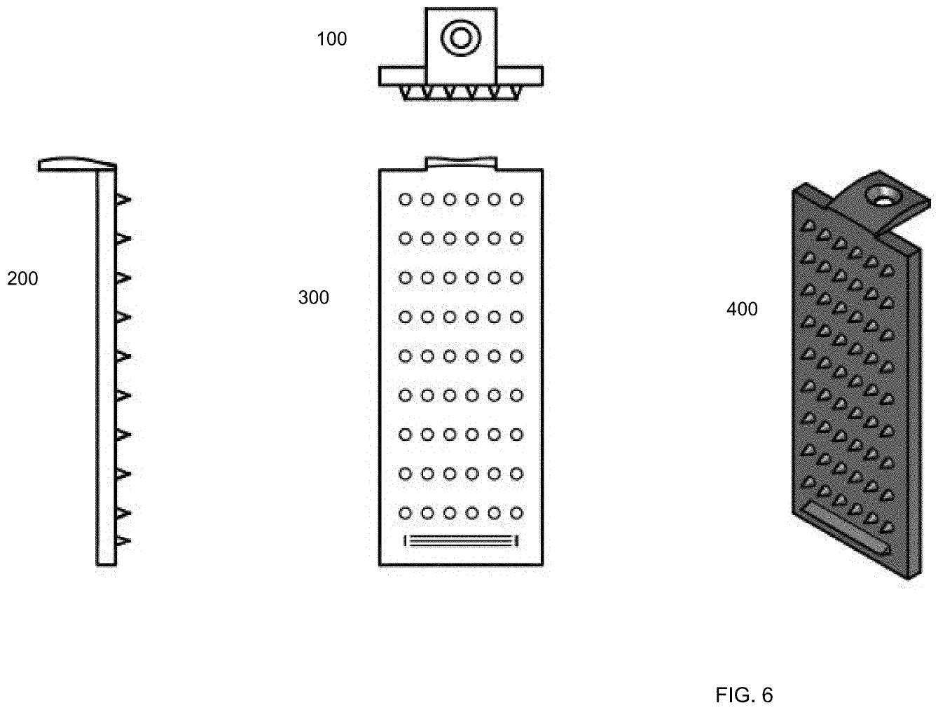

FIG. 6 illustrates, respectively, a top view 100, a side view 200, a front view 300 and a perspective view 400 of the smoothing element 6 of the above examples.

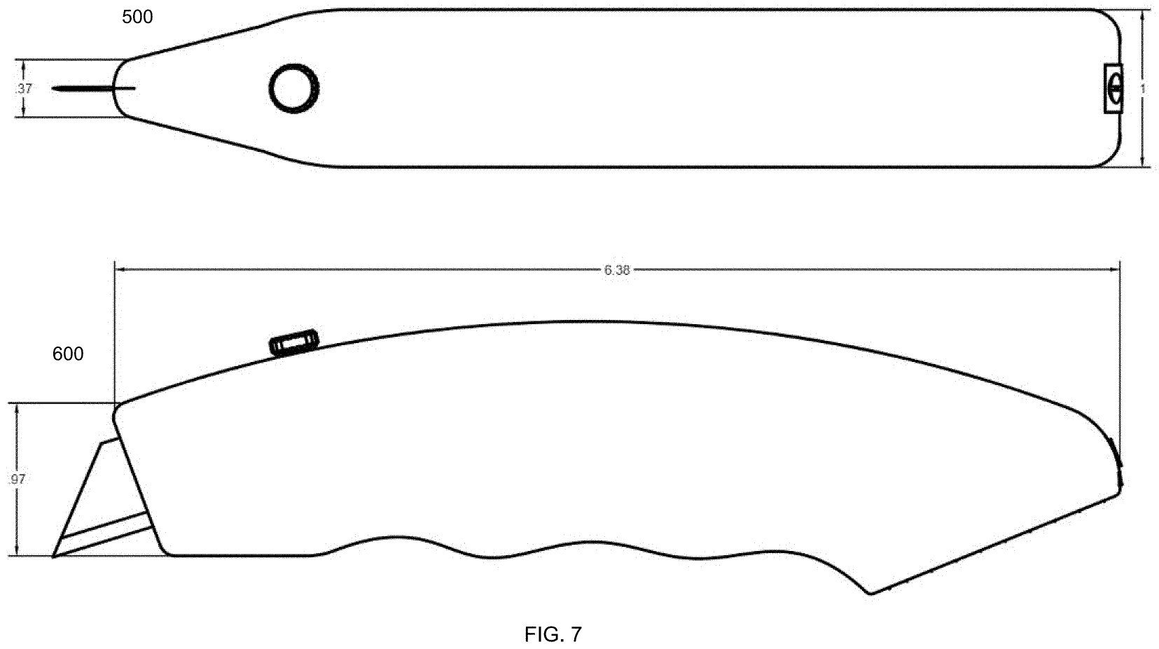

FIG. 7 illustrates a top down view 500 and a side-on view 600 of an example configuration of the utility knife of the present invention with some example dimensions. For clarity, and to give an idea of the scale of the invention, additional examples of dimensions of standard utility knives are as follows:

The handle of the utility knife is approximately 6.38″ length by 1″ width at its widest part. The tip of the handle that encompasses the blade is 0.37″. In terms of height, the grip portion in the centre is slightly enlarged reaching 1.20″.

On the front the knife a standard blade is housed and at the back it the smoothing element 6 or “flat rasp” is fitted as described above. The smoothing element 6 may be for example of dimensions 1.70″ length×0.70″ width×0.05″ thickness. The grooved elements 16 of the grooved cavity have edges approximately 3 mm high, as in extending 3 mm above the surface of a housed smoothing element.

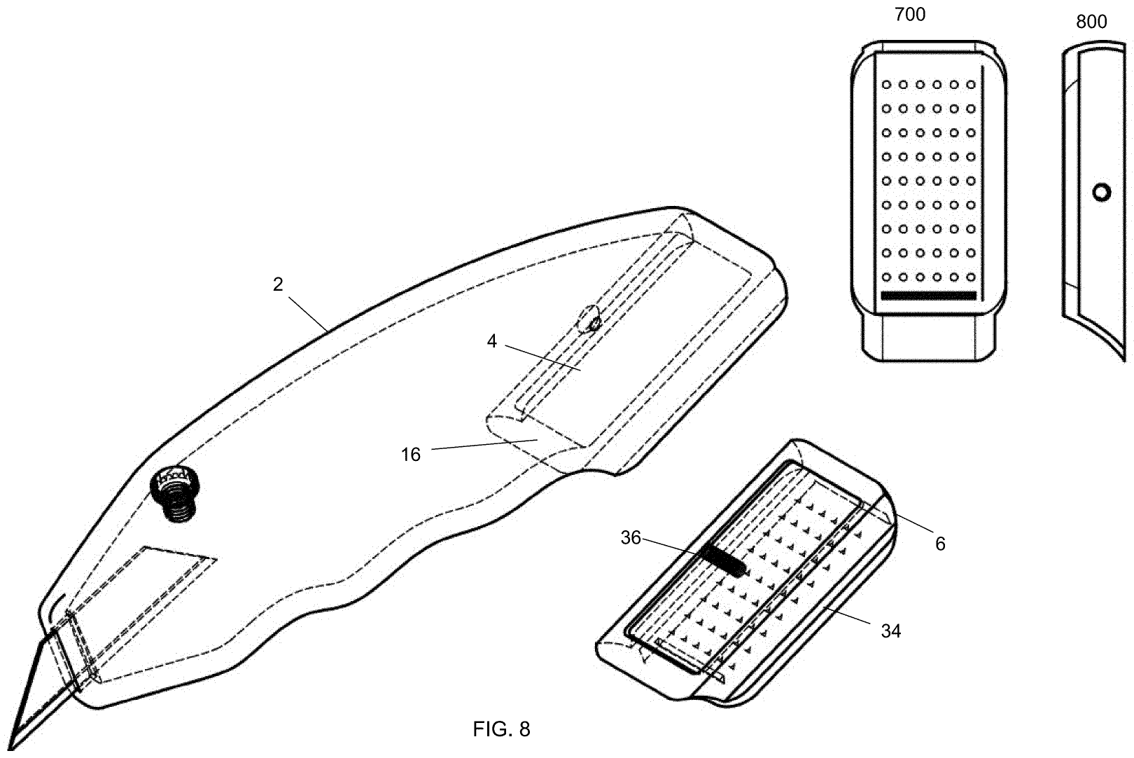

Referring to FIG. 8, a perspective view of an example configuration of a second embodiment of the present invention is shown, wherein the smoothing element 6 takes the form of a larger component.

In this example, the smoothing element 6 is in the form of a larger module composed of a rigid flat element with an abrasive surface similar to the previous embodiment, but which is set into a frame structure 34. Frame structure 34 is slotted into grooved cavity 4 and held in place by grooved structures 16 in a similar manner to the first embodiment, but with wider openings. The inclusion of frame 34 allows for different structural designs and possible retrofitting of old utility knives. For example, alternative attachment means can be constructed such as having a longer screw element 36 securing the smoothing element in place in the grooved cavity 4 from the side.

Thus, the present invention also relates to a retrofittable smoothing element 6 in the form of a frame having set therein a rigid structure with an abrasive surface.

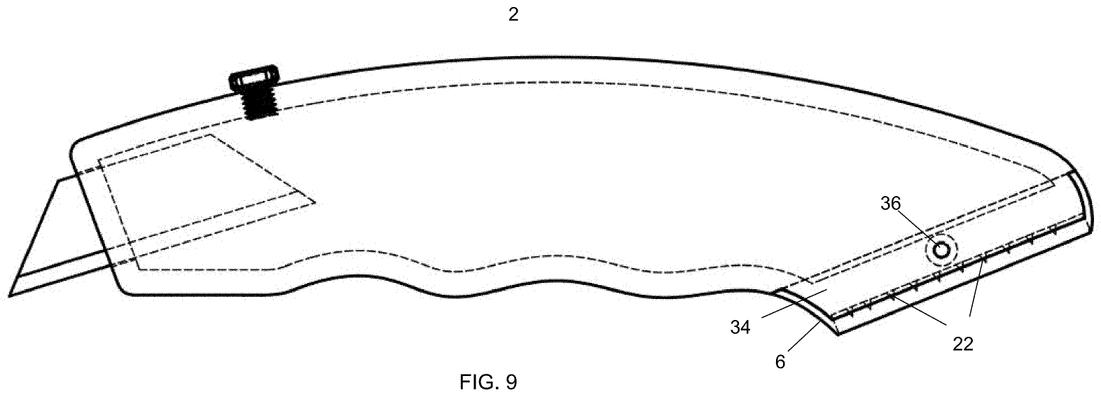

Referring to FIG. 9, a side view of the second embodiment and aspect of the invention is shown with the frame based smoothing element 6 slotted into utility knife 2 and secured in place by side screw element 36.

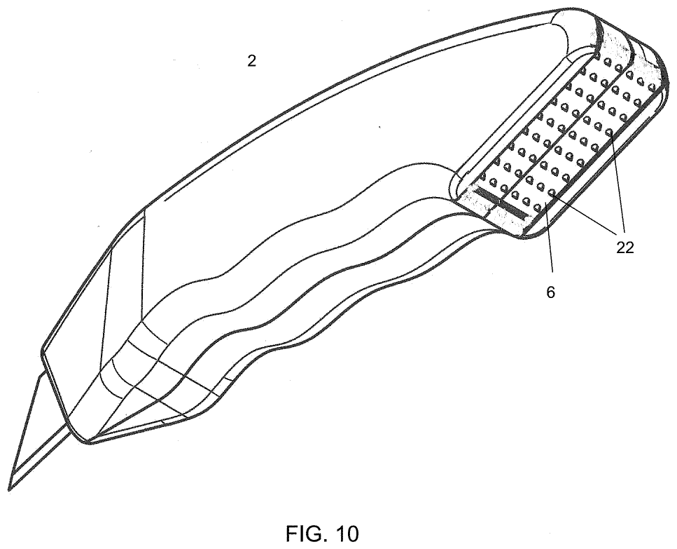

Referring to FIG. 10, a perspective view of an example configuration of a third embodiment of the present invention is shown.

The principles of the third embodiment are similar to those of the previously described embodiments, except that rather than an insertable or fixed smoothing element that can be removed from a utility knife, a utility knife is provided having an opposing end to its blade inset or “pre-molded” with a flat surface with an abrasive area comprising a plurality of spikes 22 extending from the surface. Thus, the functionality of the smoothing element 6 described in previous embodiments is still present.

This embodiment is made possible because utility knifes are usually made of resistant materials such as aluminium metal or carbon fibre, facilitating the creation of abrasive surfaces on a portion of the knife during or even post manufacture, such as a grid or array of spikes, which can serve to scratch the drywall material.

Suitable material for molding such a knife may be aluminium. The method of manufacture may involve molding two halves of the knife separately before connecting them together.

An example of how to use the utility knife apparatus of the present invention will now be provided. In a first step, a worker cuts the drywall; once it is cut or scratched, it is folded forward; the blade is passed to cut the paper that it has in the part back of the drywall sheet and two pieces remain. These two pieces have rough edges. If the blade is a retractable blade, for safety, the worker will press the button that retracts the blade; then in a final step the worker will take the smoothing element on the other side of the knife and pass the abrasive section over the edge of one of the previously cut pieces of drywall.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A utility knife, the utility knife comprising:
a first end housing a blade;
a middle grip section;
a second opposing end having a grooved cavity structured to receive and hold a smoothing element; and
a removable smoothing element having a flat surface with an abrasive area.

2. A utility knife according to claim 1, wherein the abrasive area of the smoothing element comprises one or more spikes in an array.

3. A utility knife according to claim 1, wherein the smoothing element is a flat piece of rigid material

4. A utility knife according to claim 3, wherein the grooved cavity comprises a slot having dimensions matching the smoothing element and further comprises two ridges which overhang opposing sides of the smoothing element when in place in the utility knife.

5. A utility knife according to claim 3, wherein the grooved cavity comprises a slot having dimensions matching the smoothing element, and further comprises a backstop at a distance equal to the length of the smoothing element form the front of the cavity.

6. A utility knife according to claim 3, wherein the smoothing element further comprises an attachment element along a first edge of the flat piece.

7. A utility knife according to claim 6, wherein the attachment element is in the form of an extended portion having a first opening for a screw, and the grooved cavity further comprises a second opening having matching dimensions to the first opening such that a screw may be inserted through both openings to bind the smoothing element in place in the grooved cavity.

8. A utility knife according to claim 3, wherein the rigid material of the smoothing element is aluminium.

9. A utility knife according to claim 1, wherein the smoothing element comprises a flat piece of rigid material set into a frame, the frame being shaped to slot into the grooved cavity.

10. An attachment for a utility knife, the attachment comprising a smoothing element in the form of a flat piece of rigid material set into a frame, the flat piece of rigid material having a flat surface with an abrasive area comprising a plurality of spikes extending from the surface.

11. A utility knife, the utility knife comprising:
a first end housing a blade;
a middle grip section;
a second opposing end having inset therein a flat surface with an abrasive area comprising a plurality of spikes extending from the surface.
